(19) United States
(12) Patent Application Publication
(10) Pub. No.: US 2010/0108414 A1
(43) Pub. Date: May 6, 2010

(54) DRIVE LINE

(75) Inventor: Johannes KALTENBACH, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/579,531

(22) Filed: Oct. 15, 2009

(30) Foreign Application Priority Data
Oct. 31, 2008 (DE) 10 2008 043 341.1

(51) Int. Cl. B60K 6/48; F16H 3/72

(52) U.S. Cl. 180/65.25; 475/5; 180/65.21

(57) ABSTRACT

A drivetrain of a motor vehicle, having a hybrid drive system, comprising an internal combustion engine (10), an electric motor (14), and an automatic conventional transmission (11) whose transmission output is coupled to a drive output (12). The combustion engine (10) is coupled to a transmission input of the automatic conventional transmission (11), and the electric motor 14 is coupled to a planetary gear system (15) which creates a second power path which extends parallel to a first power path created by the automatic conventional transmission (11).

This application claims priority from German patent application serial no. 10 2008 043 341.1 filed Oct. 31, 2008.

### FIELD OF THE INVENTION

The invention concerns a drivetrain of a motor vehicle, comprising at least a transmission and a hybrid drive, according to the preamble of claim 1.

### BACKGROUND OF THE INVENTION

The main components of a drivetrain of a motor vehicle are a prime mover and a transmission. The transmission transforms torques and rotational speeds, and thereby converts the traction force supplied by the prime mover. The present invention relates to a drivetrain which comprises at least an automatic conventional transmission as the transmission and, as the prime mover, a hybrid drive system with an internal combustion engine and an electric motor.

An automatic conventional transmission should in particular be understood to mean a transmission in which gearshifts are carried out automatically, with interruption of the traction force. However, an automatic conventional transmission can also be one in which gearshifts are carried out automatically, without traction force interruption.

FIG. 1 shows a drivetrain diagram known from the prior art, with a hybrid drive system comprising an internal combustion engine 1 and an electric motor 2. A transmission 3 converts the traction force supplied by the hybrid drive and delivers it to a drive output 4. In FIG. 1 a clutch 5 is located between the combustion engine 1 and the electric motor 2. In addition, in FIG. 1 a transmission-external starting element 6 is located between the electric motor 2 and the transmission 3. Instead of a transmission-external starting element 6, a transmission-internal starting element can also be present. The structure of a drivetrain with a hybrid drive shown in FIG. 1 is also called a parallel-hybrid drivetrain.

In the parallel-hybrid drivetrain known from the prior art and shown in FIG. 1, the starting element 6 is subjected to high loads. This can lead to premature wear of the starting element. Furthermore, when a transmission is used in which gearshifts are carried out automatically with traction force interruption, gearshifts cannot be carried out while maintaining the traction force at the drive output. There is therefore need for a drivetrain with which these disadvantages can be avoided.

### SUMMARY OF THE INVENTION

Starting from there, the present invention addresses the problem of providing a new type of drivetrain. According to the invention the internal combustion engine is coupled to a transmission input of the automatic change-speed transmission, and the electric motor is coupled to a planetary gear set which creates a second power path parallel to the first power path through the automatic conventional transmission.

In the concept according to the invention for a drivetrain with a hybrid drive system two power paths are provided, namely one power path through the automatic conventional transmission and another power path through the planetary gear set, with the electric motor of the hybrid drive coupled to the planetary gear set, namely to a sun gear thereof. This makes it possible, when starting off, to reduce the load on a starting element that may be present. It may even be possible to do without a starting element completely. Moreover, even when an automatic conventional transmission is used with which gearshifts are carried out with traction force interruption, gearshifts can be carried out while maintaining torque and accordingly while maintaining the traction force at the drive output. If the electric motor of the hybrid drive and/or an energy accumulator thereof should fail, the drivetrain can be operated conventionally, exclusively by the combustion engine.

### BRIEF DESCRIPTION OF THE DRAWINGS

Example embodiments of the invention, to which it is not limited, are explained in more detail with reference to the drawings, which show:

FIG. 1: Diagram of a motor vehicle drivetrain known from the prior art;

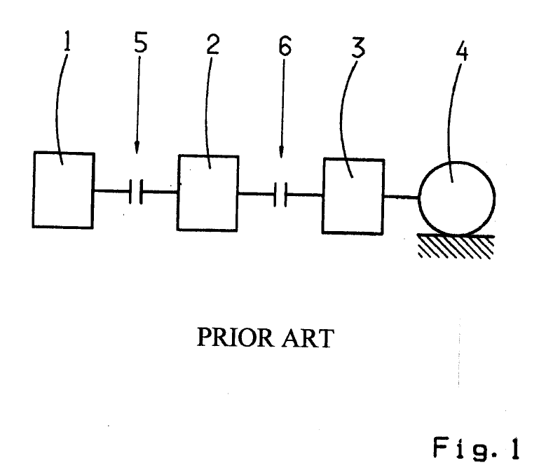

FIGS. 2 and 2A: Diagrams of a first motor vehicle drivetrain according to the invention; and

FIG. 3: Diagram of a second motor vehicle drivetrain according to the invention.

### DETAILED DESCRIPTION OF THE PREFERRED EMBODIMENTS

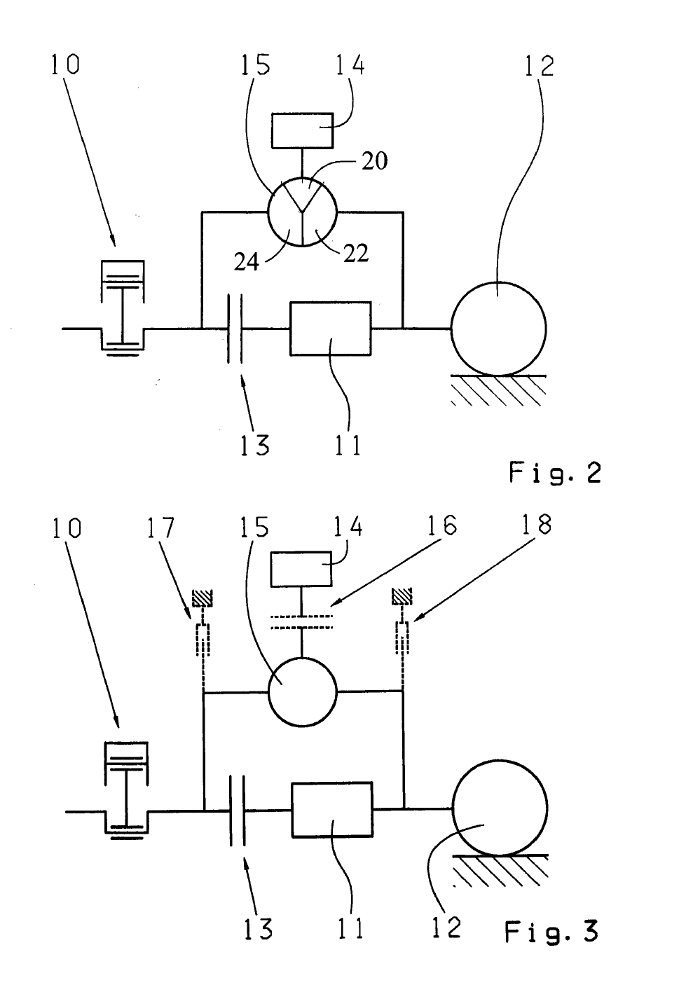

FIGS. 2 and 2A show a first example embodiment of a motor vehicle drivetrain according to the invention such that, as shown in FIGS. 2 and 2A, the drivetrain comprises an internal combustion engine 10, a transmission 11 and a drive output 12. In FIGS. 2 and 2A the combustion engine 10 is coupled to the transmission input of the transmission 11 with an interposed starting element 13, the transmission 11 in question being an automatic conventional transmission. With an automatic conventional transmission, shifting operations and thus gearshifts are carried out automatically, in particular with traction force interruption in the transmission 11. The transmission output of the transmission 11 is coupled to the drive output 12.

In addition, the drivetrain of FIGS. 2 and 2A has an electric motor 14 coupled to a planetary gear set 15, so that the planetary gear set 15 forms a power path that extends parallel to the power path formed by the automatic conventional transmission 11. The power path of the planetary gear set 15 extends parallel to the automatic conventional transmission and to the starting element 13.

The electric motor 14 engages a sun gear of the planetary gear set 15. In a first variant, shown in FIG. 2, the internal combustion engine 10 engages a ring gear 24 of the planetary gear set 15 and the drive output 12 with a carrier 22 of the planetary gear set 15. In a second alternative, shown in FIG. 2A, the combustion engine 10 is coupled to the carrier 22 of the planetary gear set 15 and the drive output 12 to the ring gear 24 of the planetary gear set 15.

In the case of the drivetrain shown in FIGS. 2 and 2A, the drivetrain starts up and/or maneuvers and/or crawls when a driver's-wish-dependent drive output torque is delivered to the drive output 12, with the electric motor 14 coupled to the planetary set 15 supporting the torque supplied by the internal combustion engine 10 as much as possible and transmitting it, via the planetary gear set 15, to the drive output 12, whereas in contrast the starting element 13 converts as little as possible of the torque supplied by the combustion engine 10 and delivers it, via the automatic conventional transmission 11, to the drive output 12, so that in total the driver's-wish-dependent output torque is delivered to the drive output 12.

Accordingly, to start off and/or maneuver and/or crawl, torque desired by the driver for the drive output 12 is determined and so far as possible this desired output torque, which is supplied by the internal combustion engine 10, is delivered to the drive output 12 via the power path of the automatic conventional transmission 11. The torque that can be supported by the electric motor 14 at the planetary gear set 15 and thus the torque that can be delivered to the drive output 12 via the power path of the planetary gear set 15 depends on the size of the electric motor 14 and on the size of an electrical energy accumulator of the drivetrain.

In the event that the driver's-wish-dependent drive output torque for starting off, maneuvering or crawling can be supplied to the drive output 12 completely via the power path with the planetary gear set 15, the starting element 13 can also be or remain fully open and this enables wear-free starting, maneuvering or crawling.

In the drivetrain shown in FIGS. 2 and 2A, if a shift or gear-change operation is to take place in the automatic conventional transmission 11, then this can be done with the starting element 13 either open or closed. In either case, to carry out a shift operation in the automatic conventional transmission 11, torque supplied by the internal combustion engine is supported with the help of the electric motor 14 at the planetary gear set 15, to enable a shift without interruption of the traction force, since via the power path of the transmission 12 a drive output torque is delivered to the drive output 12 even when carrying out a shift in the automatic conventional transmission 11.

In the drivetrain shown in FIGS. 2 and 2A, if a shift operation is to take place in the automatic conventional transmission 11 with the starting element 13 at least partially open, then the internal combustion engine 10 reduces the torque it delivers at the same time as the torque at the planetary gear set 15 is being supported, to an extent that enables the starting element 13 to be opened while free from torque. Using transmission-internal synchronizers, the automatic conventional transmission 11 then carries out a gearshift from a current gear to a target gear, the starting element 13 then closes and the combustion engine 10 builds up its load and therefore the torque that it supplies. Transmission-internal synchronization is also referred to as passive synchronization, which operates by means of transmission-internal synchronizing devices.

As already mentioned, in the drivetrain shown in FIGS. 2 and 2A gearshifts in the automatic conventional transmission 11 can even be carried out with the starting element 13 closed, and to do this the combustion engine 10 reduces the torque it is supplying at the same time as the torque at the planetary gear set 15 is being supported, to an extent such that the transmission input of the automatic change-speed transmission 11 is or becomes free from load. After the current gear has been disengaged, to carry out the gearshift a transmission-external synchronization takes place, the target gear is engaged in the automatic conventional transmission 11, and the combustion engine 10 then increases the torque it is supplying and builds up a load again. Transmission-external synchronization is also referred to as active synchronization and takes place when the combustion engine 10 and/or the electric motor 14 adapts the torque at the transmission input of the automatic conventional 11 to the change of rotation speed, after the current gear has been disengaged and before the target gear has been engaged.

In the drivetrain shown in FIGS. 2 and 2A, if the combustion engine 10 is to be actively stopped or actively started, then for example a vehicle brake of the drivetrain supports the torque delivered by the combustion engine 10 and at the same time the automatic conventional transmission 11 adopts a neutral position and/or the starting element 13 is opened. Alternatively, for active starting of the combustion engine 10 or for active stopping thereof, it is possible for the automatic conventional transmission 11 to be locked and the starting element opened.

In the drivetrain shown in FIGS. 2 and 2A a so-termed boost can be produced when the starting element 13 is closed and a gear is engaged in the automatic conventional transmission 11 by operating the electric motor 14 as a motor. If the starting element 13 is closed and a gear is engaged in the automatic conventional transmission 11, then if the electric motor 14 is operated as a generator, so-termed recuperation takes place.

According to a further development of the present invention, the starting element 13 in FIGS. 2 and 2A can even be omitted and the power path of the planetary gear set 15 is then again parallel to the power path of the automatic conventional transmission 11. Even when there is no starting element 13 and the combustion engine 10 is therefore coupled directly to the transmission input of the automatic conventional transmission 11, the above functions of starting off, maneuvering, crawling, shifting, starting and stopping the combustion engine 10, boosting and recuperation can all be carried out.

When the combustion engine 10 is directly coupled to the transmission input of the automatic conventional transmission without a starting element 13 interposed between them, starting off and/or maneuvering and/or crawling of the drivetrain takes place by the supply of a driver's-wish-dependent output torque to the drive output 12 exclusively by the electric motor 14 and the planetary gear set 15, and to do this the automatic conventional transmission 11 adopts a neutral position and the size of the electric motor 14, as well as that of an electrical accumulator associated with the electric motor 14, are chosen having regard to the maximum driver's-wish-dependent output torque possible.

A shift operation and hence gear-change in the automatic conventional transmission 11 in a drivetrain with no starting element 13, takes place analogously to the shift with a closed starting element 13 described with reference to FIGS. 2 and 2A.

Active starting and active stopping of the combustion engine 10 also take place as described in connection with FIGS. 2 and 2A, with the automatic conventional transmission 11 in a neutral position and the torque supplied by the combustion engine 10 supported by a vehicle brake.

In a drivetrain with no starting element 13, boosting and recuperation take place as described above, analogously to a drivetrain having a starting element 13.

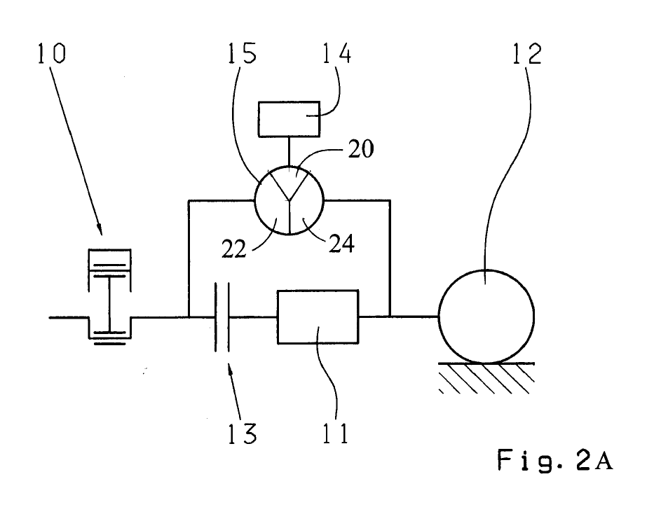

FIG. 3 shows another advantageous design of the drivetrain according to the invention, such that in FIG. 3 a clutch 16 is interposed between the electric motor 14 and the planetary gear set 15. With the help of this separating clutch 16 the electric motor 14 can be decoupled from the planetary gear set 15, for example in order to avoid zero-load losses. If the clutch 16 is not present, the electric motor 14 always has to rotate together with the planetary gear set 15 and, depending on the fixed transmission ratio of the latter and its connection thereto, can reach considerably higher speeds than the combustion engine 10.

According to another advantageous development of the invention, a brake 17 engages in the second power path between the combustion engine 10 and the planetary gear set 15, the brake 17 acting on a crankshaft of the combustion engine 10. Actuation of this brake 17 enables purely electric-powered driving and recuperation with the combustion engine 10 stopped. For this, the starting element 13 is open and the automatic conventional transmission 11 is in its neutral position.

Likewise, a brake 18 can act in the second power path between the planetary gear set 15 and the drive output 12, so that actuation of the brake 18 enables active starting and active stopping of the combustion engine 10 by the electric motor 14 when at rest.

### INDEXES

1. Internal combustion engine
2. Electric motor
3. Transmission
4. Drive output
5. Clutch
6. Starting element
10. Internal combustion engine
11. Transmission
12. Drive output
13. Starting element
14. Electric motor
15. Planetary gear set
16. Clutch
17. Brake
18. Brake
20. Sun gear
22. Carrier
24. Ring gear

1-18. (canceled)

19. A drivetrain of a motor vehicle with a hybrid drive system comprising:
an internal combustion engine,
an electric motor, and
an automatic conventional transmission with a transmission output coupled to a drive output,
the internal combustion engine (10) being coupled to a transmission input of the automatic conventional transmission (11), and the electric motor (14) being coupled to a planetary gear set (15) which forms a second power path extending parallel to a first power path formed by the automatic conventional transmission (11).

20. The drivetrain according to claim 19, wherein the electric motor (14) is coupled to a sun gear (20) of the planetary gear set (15), the combustion engine (10) is coupled to a ring gear (24) of the planetary gear set (15) and the drive output (12) is coupled to a carrier (22) of the planetary gear set (15).

21. The drivetrain according to claim 20, wherein the electric motor (14) is coupled to a sun gear (20) of the planetary gear set (15), the combustion engine (10) is coupled to a carrier (22) of the planetary gear set (15) and the drive output (12) is coupled to a ring gear (24) of the planetary gear set (15).

22. The drivetrain according to claim 19, wherein a starting element (13) is located between the combustion engine (10) and the automatic conventional transmission (11) and the second power path of the planetary gear set (15) extends parallel to both the automatic conventional transmission (11) and the starting element (13).

23. The drivetrain according to claim 19, wherein a clutch (16) is located between the electric motor (14) and the planetary gear set (15).

24. The drivetrain according to claims 19, wherein a brake (17) engages in the second power path between the combustion engine (10) and the planetary gear set (15).

25. The drivetrain according to claim 19, wherein a brake (18) engages in the second power path between the planetary gear set (15) and the drive output (12).

26. The drivetrain according to claim 19, wherein at least one of starting off, maneuvering and crawling of the drivetrain takes place by delivery of a driver dependent output torque to the drive output when the combustion engine (10) acts indirectly, via the starting element (13), on the transmission input of the automatic conventional transmission (11), the electric motor (14) provides as much torque as possible to support torque supplied by the combustion engine (10) and delivers the torque, via the planetary gear set (15), to the drive output (12), and the starting element (13) transmits as little torque as possible, supplied by the combustion engine (10), and delivers the torque, via the automatic conventional transmission (11), to the drive output (12), so as to deliver the driver dependent drive output torque to the drive output (12).

27. The drivetrain according to claim 26, wherein the torque supplied by the electric motor (14), to the planetary gear set (15), depends on a size of the electric motor and a capacity of an electrical energy accumulator.

28. The drivetrain according to claim 19, wherein when the combustion engine (10) acts directly on the transmission input of the automatic conventional transmission (11), without a starting element interposed therebetween, at least one of starting off, maneuvering and crawling of the drivetrain with delivery of a driver dependent output torque to the drive output takes place exclusively by the electric motor (14) and the planetary gear set (15), and the automatic conventional transmission (11) adopts a neutral position.

29. The drivetrain according to claim 28, wherein a size of the electric motor (14) and a capacity of an electrical energy accumulator are selected depending on a maximum possible driver dependent drive output torque.

30. The drivetrain according to claim 19, wherein the electric motor (14) supports torque supplied by the combustion engine (10) to the planetary gear set (15), when a shift operation is carried out in the automatic conventional transmission (11), to facilitate a shift without traction force interruption.

31. The drivetrain according to claim 30, wherein to facilitate the shift without traction force interruption, when the combustion engine (10) acts on the transmission input of the automatic conventional transmission (11) indirectly with a starting element (13) interposed between the combustion engine (10) and the automatic conventional transmission (11), the combustion engine (10) reduces any amount of torque the combustion engine (10) delivers while, at the same time, supports torque to the planetary gear set (15), to an extent that the starting element (13) disengages while free from torque, and then using transmission-internal synchronization the automatic conventional transmission (11) carries out a gearshift from a current gear to a target gear, and subsequently the starting element (13) engages and the combustion engine (10) increases the torque the combustion engine (10) is delivering.

32. The drivetrain according to claim 30, wherein to facilitate the shift without traction force interruption, when the combustion engine (10) acts on the automatic conventional transmission (11) either directly, without an starting element (13) interposed between the combustion engine (10) and the automatic conventional transmission (11), or indirectly, with the starting element (13) interposed between the combustion engine (10) and the automatic conventional transmission (11), the starting element(13), if present, remains engaged and the combustion engine (10) reduces torque the combustion engine (10) delivers while, at the same time, supporting torque to the planetary gear set (15), to the extent that the transmission input of the automatic conventional transmission (11) is free from torque, and then, using transmission-external synchronization, the automatic conventional transmission (11) carries out a gearshift from a current gear to a target gear, and subsequently the combustion engine (10) increases the torque the combustion engine (10) is delivering.

33. The drivetrain according to claim 32, wherein for the transmission-external synchronization of at least one of the combustion engine (10) and the electric motor (14), torque applied at the transmission input is adapted after the current gear has been disengaged and before the target gear has been engaged.

34. The drivetrain according to claim 32, wherein for one of active stopping and active starting of the combustion engine (10), a vehicle brake supports torque supplied by the combustion engine (10) and, at the same time, at least one of the automatic conventional transmission (11) adopts a neutral position and the starting element (13) disengages.

35. The drivetrain according to claim 22, wherein for the active stopping or active starting of the combustion engine (10), the automatic conventional transmission (11) is blocked and the starting element (13) is disengaged.

36. A method for operating a drivetrain having a hybrid drive system comprising an internal combustion engine, an electric motor and an automatic conventional transmission with a transmission output coupled to a drive output, the internal combustion engine (10) being coupled to a transmission input of the automatic conventional transmission (11), and the electric motor (14) being coupled to a planetary gear set (15) which forms a second power path parallel to a first power path formed by the automatic conventional transmission (11).

37. A drivetrain of a motor vehicle comprising:
an internal combustion engine (10) being coupled, via an engine output, to a starting element (13) and one of a ring gear (24) and a carrier (22) of a planetary gearset (15);
an electric motor being coupled to a sun gear (20) of the planetary gearset (15);
a drive output (12) being coupled to both an output of the transmission (11) and another one of the ring gear (24) and the carrier (22) of the planetary gearset (15); and
an input of a transmission (11) being coupled to the starting element (13) such that the internal combustion engine (10), the starting element (13), the transmission (11) and the drive output (12) form a first power path and the internal combustion engine (10) being coupled to the planetary gearset (15) and the drive output (12) to form a second power path so that the first power path and the second power path are parallel to one another.
